(19) United States
(12) Patent Application Publication
(10) Pub. No.: US 2020/0118044 A1
(43) Pub. Date: Apr. 16, 2020

(54) COMPUTER-IMPLEMENTED METHOD FOR AUTHENTICATING EVENT ATTENDANCE

(71) Applicant: Live Music Loyalty LLC, Asbury Park, NJ (US)

(72) Inventor: Jeffrey Warshauer, Atlantic Highlands, NJ (US)

(21) Appl. No.: 16/161,743

(22) Filed: Oct. 16, 2018

(51) Int. Cl. G06Q 10/02; H04W 4/021; G06F 17/30

(52) U.S. Cl. CPC G06Q 10/02; G06F 17/30241; G06F 17/30029; H04W 4/021

(57) ABSTRACT

A method for authenticating attendance by a user at an event uses media metadata captured at the event, A user device is searched for media metadata that was created during a predetermined period and a list of cities with corresponding dates on which the media was captured is created. At least one database is searched for a first set of events, each of which has an event location and date corresponding with at least one entry from the list of cities. The user device is then searched for metadata that has a creation date within a start and end date of at least one event from the first set of events and was created'within a predetermined radius of the event location. For any media metadata that matches a location radius of the event and one, of the start and end dates of the event, user attendance at the event is authenticated. Preferably, the method is initiated by the user and is implemented via computer readable instructions and at least one processor.

### BACKGROUND OF THE DISCLOSURE

The present disclosure relates to a method for authenticating attendance for an event, and more specifically to authenticating attendance for an event based on user media metadata.

Live events including performance by musical acts, sports teams, and actors, to name a few, are exciting and entertaining for attendees, Beyond the experience at an event, attendees often like to memorialize their time at the event by capturing photographs, videos or other types of digital media on their cell phone, tablet, digital camera or other device. Some attendees also like to demonstrate their attendance to others by posting pictures on social media websites, sending pictures to family and friends via text message or email, or even “checking-in” to an event online.

The current process used to check-in to an event can be user driven and done by users announcing via social media websites their attendance at an event or via a text message or email to others that they are at or were at an event. The process can also be made automatic if a person chooses prior to attending an event to share his or her location with others. Less direct forms of “checking-in” might involve posting pictures or other media on a social network without directly stating a user's attendance at an event.

Further, some users prefer to check-in to an event for their own memory and not to share that check-in with others. People may save photographs or ticket stubs to an event to remind themselves of the events they have attended, This method, however, is not always sufficient. Photographs may not provide enough information and ticket stubs can be cumbersome to keep track of.

It is therefore desirable to have a method for checking-in to an event that overcomes the above drawbacks so that a user may more easily have his or her attendance at an event authenticated to share that information with others or memorialize the event for himself or herself.

### SUMMARY OF THE DISCLOSURE

Accordingly, it is an object of the present disclosure to provide a method for authenticating attendance by a user at an event through media captured at the event. A user device is searched for media metadata that was created during a predetermined time period and a list of cities with corresponding dates on which the media was captured is created. At least one database is searched for a first set of events, each of which have an event location and date corresponding with at least one entry from the list of cities. The user device is then searched for metadata that has a creation date within a start and end date of at least one event from the first set of events and was created within a predetermined radius of the event location. For any media metadata that matches a location radius of the event and one of the start and end dates of the event, user attendance to the event is authenticated. Preferably, the method is initiated by the user and is implemented via computer readable instructions and at least one processor.

An alternate embodiment of the method further includes the step of searching the user device for additional media metadata captured subsequent to the predetermined period until a predetermined end date. The list of cities is then updated accordingly. Preferably, the additional searches include successive periods equivalent in duration to the predetermined period until reaching the date on which the method is executed. It is also preferable to search and filter the database for additional sets of events that are equivalent in number to the first set of events, until all events that have occurred up to the date on which the method is executed have been searched.

In a separate embodiment, a list of cities having a date range associated with each city including first and last dates that media metadata was captured within the city is created.

In another embodiment, events on the database are searched in an order according to the list of cities arranged in descending order from cities in which the greatest number of media metadata was captured to cities in which the least number of media metadata was captured.

In yet another embodiment, at least one database is searched with at least one parameter in addition to the event location and date, which is preferably one of the user's age and preferred event.

### BRIEF DESCRIPTION OF THE FIGURES

Other objects and advantages of the disclosure will become apparent from a study of the following specification when viewed in the light of the accompanying drawing, in which:

FIG. 1 is a flow chart of the method steps for authenticating user attendance according to one embodiment of the present disclosure;

FIG. 2 is a decision tree for how user attendance is authenticated according to one embodiment of the present disclosure; and

FIG. 3 is a schematic for how the method steps or one embodiment of the present disclosure are implemented with a user device.

### DETAILED DESCRIPTION

The method for authenticating event attendance of the present disclosure provides an automated process for users to track events he or she have attended. It verifies attendance at past events by synchronizing a device application with the media galleries on a user device. The method matches metadata from user media to a database of georeferenced events. To optimize this process, the method is structured to exclude irrelevant events while prioritizing the most relevant. In doing so, the automated process quickly and easily builds a user events history and links them with artists, bands, venues and other users that were at an event.

The method is automated to check new media against new events, or selectively engaged so that the user can choose when the method is implemented. Whether automated or selectively engaged, all media on a user device is searched for geolocation metadata and a program on the user device creates a list of cities with date ranges that are used to filter'and request events from a database. Events are sequenced by factors specific to that user which may include personalized characteristics drawn from the platform, such as a user's favorite artist, a previously saved event, demographic characteristics of a user, or a number of different parameters that improve the sorting and processing of the events for matching with user media metadata.

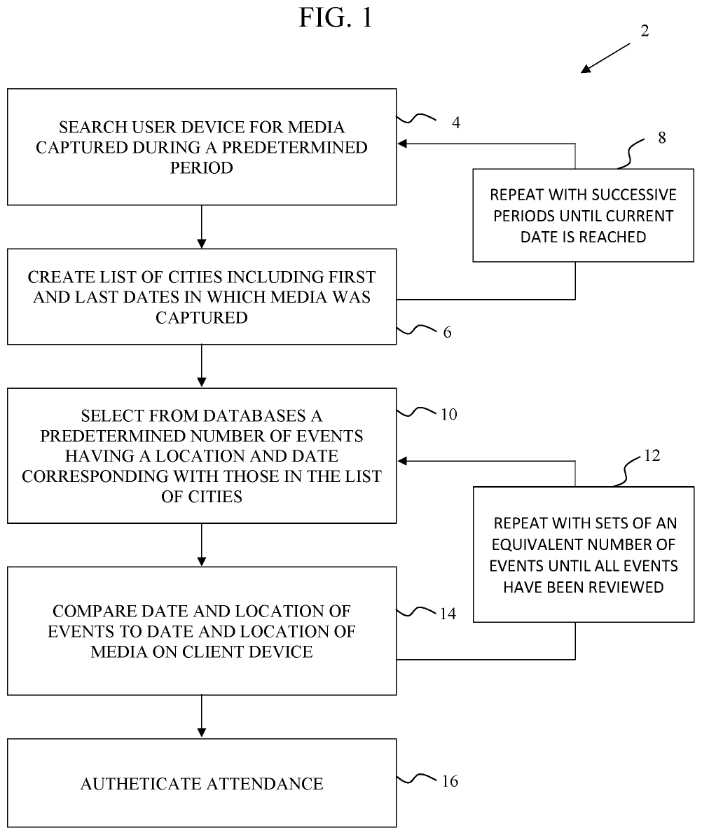

Referring first to FIG. 1, the method for authenticating attendance by a user at an event through media captured at the event 2 is shown. A user device is searched for media captured during a predetermined period based on media metadata 4. For instance, the device could be searched over a 30-day period. Preferably, the user device is a cell phone, tablet or similar hand-held device. However, any device which can store media having metadata could also be used. As a result of searching the device, a list of cities in which media was captured during the predetermined period is created 6. The list includes dates when all media was captured within a city. This process is then repeated 8, and the list updated, for as many times as necessary until reaching the date on which the process was initiated. The dates associated with the list of cities are recorded as a date range including the first and last days on which media was captured in a given city. It will be understood by those of ordinary skill in the art that the dates could be recorded in a different way, for instance, by recording each specific date.

Searching the device and creating a list of cities is performed by a program which includes computer-readable instructions. Preferably, the program is located on the device. However, it will be understood by those with skill in the art that the program could be stored remotely and accessed by the device via a network, for instance, a computer or telecommunications network.

Once the list is created 6, at least one database is searched 10 by an application processor for a first set of events that have an event location and date corresponding with at least one entry from the list of cities. The database and application processor are remotely located, and the user device communicates the contents of the list with the application processor via a network. Preferably, the database is searched for additional sets of events 12 that are equivalent in number to the first set of events until searching all events that have occurred up to the date on which the method is executed. For example, a first set of 50 events is searched, and then successive sets of 50 events are searched until all events in the database have been searched, For media on the user device and events in the database, those that have been searched and analyzed during previous implementations of the method are noted and removed from future searches.

Once relevant events have been noted, the user device is searched for media that is relevant to the event 14. Specifically, the device is searched for media that has a creation date within a start and end date of an event and was captured within a predetermined radius of the event location. For any media that matches a location radius of the event and one of the start and end dates of the event, user attendance to the event is authenticated 16.

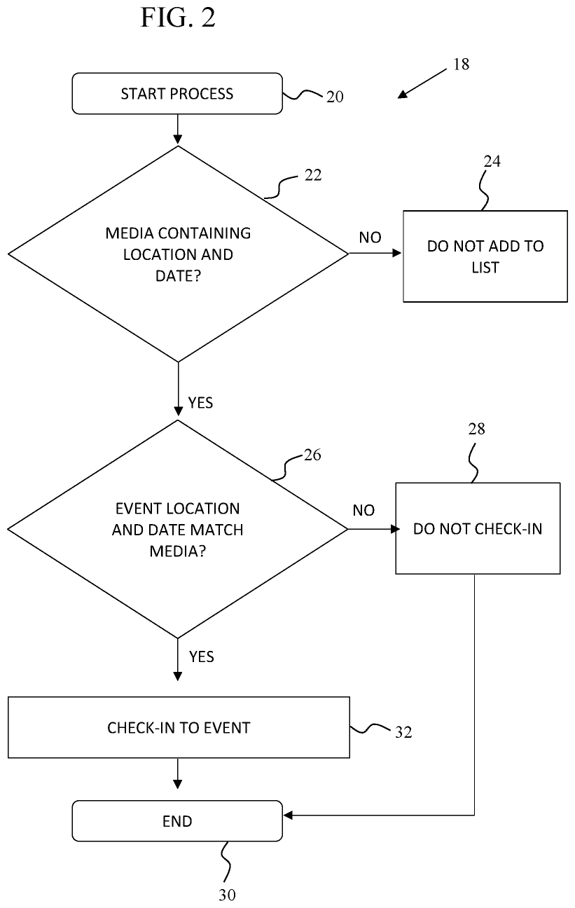

FIG. 2 shows one example of how the authentication process 18 is carried out. The process starts 20 once at least one event that matches the criteria from the list of cities described above is found. First, all media on a user device is reviewed to determine if it has location and date metadata 22. If it does not, it is not used in the process 24. If it does, however, the location and date of the metadata are compared to the event location and start and end dates of the event 26. If the data does not match, user attendance is not authenticated 28 and the process ends 30. If, however, it does match, user attendance is authenticated 32 and the process ends 30. The authentication process is repeated for every event that matches the criteria from the list of cities.

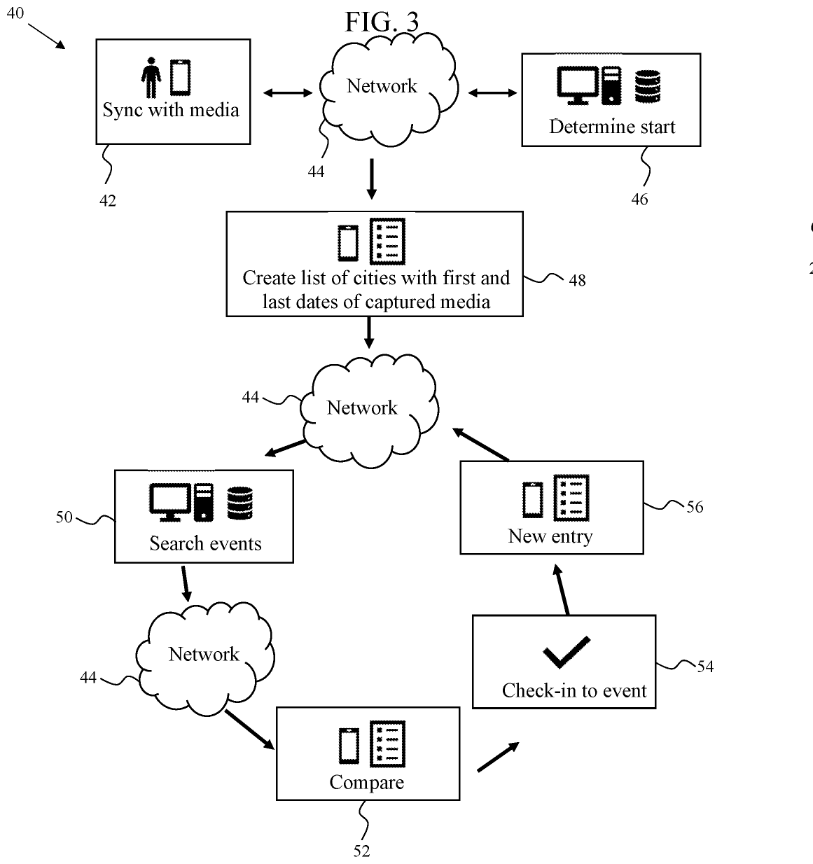

FIG. 3 shows one example of how the method steps described above could be implemented 40. First, the user synchronizes his or her photographs 42 to start the automatic check-in process. The program on the device communicates with an application processor via a network 44 and requests the start date of the oldest event in the database, which the processor sends back 46 to the device. Any events that have been previously searched are not included. The user device then searches for photos beginning with the first date and up to the present and creates a list of all cities in which media was captured according to media metadata 48. If, for instance, twenty photographs were found with metadata, but those photographs were taken in only three cities, a list of three cities would be created. That list is organized in descending order, from the city with the most photos to the city with the least photos. Each city includes a first and last date on which a photo was taken in that city. To create the list, the program on the device uses reverse geocoding to determine the city in which the photos were captured.

The application processor receives the first city on the list via the network 44 and searches for events 50 that match the city and associated date range. The processor then sends the list of events that match the city and date range to the user device via the network 44 and the user device compares the data to media metadata on the user device 52. For media that was captured within the start and end date of the event and within a radius of the location of the event, the user application notes the user as checked-in to the event 54. The device then sends the next city in the list of cities to the application processor 56 for further searching. Once all cities have been searched and the device has checked-in the user accordingly, the program ceases implementing the method until the next user-initiated search.

Although the above description is with reference to particular embodiments, it is to be understood that these embodiments are merely illustrative of the principles and applications of the present disclosure. It is therefore to be understood that numerous modifications may be made to the illustrative embodiments and that other arrangements may be devised and employed without departing from the spirit and scope of the present disclosure.

What is claimed is:

1. A computer-implemented method for authenticating attendance by a user at an event through media captured at the event, comprising:
(a) searching a user device for media metadata created during a predetermined period;
(b) creating a list of cities in which media was captured during the predetermined period including dates media was captured for each city;
(c) searching at least one database for a first set of events that have an even location and date corresponding with at least one entry from the list of cities;
(d) searching the user device for media that has a creation date within a start and end date of at least one event from the first set of events and was captured within a predetermined radius of the event location; and
(e) authenticating attendance of the user to each event for which media matches a location radius of the event and one of the start and end date of the event.

2. A computer-implemented method for authenticating attendance at an event, as defined in claim 1, and further comprising the step of searching the user device for additional media captured subsequent to the predetermined period until a predetermined end date and updating the list of cities accordingly.

3. A computer-implemented method for authenticating attendance at an event as defined in claim 2, wherein said searching the user device for additional media step includes searching successive periods equivalent in duration to the predetermined period.

4. A computer-implemented method for authenticating attendance at an event as defined in claim 2, wherein the predetermined end date is the date on which the method is executed.

5. A computer-implemented method for authenticating attendance at an event as defined in claim 1, wherein said searching a user device step begins on a date following a previous search.

6. A computer-implemented method for authenticating attendance at an event as defined in claim 1, wherein said creating a list of cities step further includes a list of cities having a date range associated with each city including first and last dates that media was captured within the city.

7. A computer-implemented method for authenticating attendance at an event as defined in claim 1, and further including the step of searching and filtering the at least one database for sets of events that are equivalent in number to the first set of events until a predetermined number of events has been searched;

8. A computer-implemented method for authenticating attendance at an event as defined in claim 7, wherein the predetermined number of events includes all events that have occurred up to the date on which the method is executed.

9. A computer-implemented method for authenticating attendance at an event as defined in claim 1, wherein said searching at least one database step is completed according to the list of cities arranged in descending order from cities in which the greatest number of media was captured to cities in which the least number of media was captured.

10. A computer-implemented method for authenticating attendance at an event as defined in claim 1, wherein said searching at least one database step further includes at least one parameter in addition to the event location and date.

11. A computer-implemented method for authenticating attendance at an event as defined in claim 11, wherein the at least one parameter is one of the user's age and preferred event.

12. A computer-implemented method for authenticating attendance at an event as defined in claim 1, wherein events for which attendance of the user was previously authenticated are eliminated from subsequent searching and authenticating.
